(19) United States
(12) Patent Application Publication
(10) Pub. No.: US 2005/0163153 A1
(43) Pub. Date: Jul. 28, 2005

(54) Method for mixing data streams

(75) Inventor: Peter Handel, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/039,592

(22) Filed: Jan. 20, 2005

(30) Foreign Application Priority Data
Jan. 23, 2004 (DE) 10 2004 003 609.8

(51) Int. Cl. H04L 12/28

(52) U.S. Cl. 370/463

(57) ABSTRACT

A method for mixing data streams (BS) is specified, whereby the mixing is carried out in a digital signal processor (DSP) of an ISDN interface module (IC), and the control of the data streams (BC) is managed by a module for communication according to the Media Gateway Control Protocol (MGCP), which replaces the control of a B channel in the ISDN interface module (IC). Furthermore, a telecommunication terminal with an ISDN interface module (IC) is specified for implementing the method according to the invention.

### CROSS REFERENCE TO RELATED APPLICATIONS

This application claims priority to the German application No. 10 2004 003 609.8, filed Jan. 23, 2004 and which is incorporated by reference herein in its entirety.

### FIELD OF INVENTION

The invention relates to a method for mixing data streams and a telecommunication terminal with an ISDN interface module for implementing the method according to the invention.

### BACKGROUND OF INVENTION

The increasing use of packet data networks for voice services is resulting in the need to adapt existing equipment set up for switching-oriented communication networks so that it can be used in packet data networks.

This also applies, for example, for so-called “Computer Telephony Integration” technology, abbreviated to CTI. CTI supports telephone services using computer technology. As well as support for service features with their various switching functions, this also includes the management of a telecommunication system, and charge registration. The functional features include intelligent, network-capable call control, the automation of management functions within a call center; and software-controlled and database-controlled ACD functions and mechanisms for registering and displaying stored and evaluated contact data.

One of the services which can also be implemented with the help of CTI technology is conference calling involving 3 or more subscribers, which is known—according to the prior art—for switching-oriented communication networks. A solution is also known whereby data streams which contain the voice data of the telephone conference subscribers, known as “media streams”, are sent in the form of data packets. In this solution, the incoming streams from the different subscribers are mixed in a terminal, for example a personal computer provided for this purpose, and output there via a loudspeaker. At the same time the voice signal registered via a microphone is converted into an outgoing media stream.

For example, if a conference takes place between a subscriber A, a subscriber B and a subscriber C, and assuming that the individual media streams are mixed on the personal computer of subscriber B, than not only are the data streams from subscriber A and C mixed and output via a loudspeaker B, but the data streams from subscriber A and B are also mixed and the data stream obtained is transferred to subscriber C as well as the data streams from subscribers B and C, with the data stream obtained being sent to subscriber A.

Furthermore, a device known as a “codec” is required for converting a data stream into a voice signal and vice versa. “Codec” is an artificial word that stands for “compression und decompression”. A codec is a functional hardware or software unit which modifies audio or video signals according to predefined procedures in real time. These procedures are standardized by the ITU and are described, for example, in ITU Recommendations H.321 and H.323. Codecs are used in multimedia technology, audio communication and video communication, in which wide variations in image or sound quality may occur as a result of different compression algorithms. Examples of software codecs are Quicktime and Video for Windows, whilst an example of a hardware codec is MPEG.

In a conference call according to the prior art, the data streams are mixed—as well as being compressed/decompressed—by the processor in the PC. This causes the functionality of the device to be limited due to the high processing power required. Furthermore, this also necessitates extensive modifications to the software in order to replicate, for a packet data network, the functions that are available for a switching-oriented communication network.

### SUMMARY OF INVENTION

The object of the invention is therefore to provide a method for mixing data streams, wherein existing equipment and the corresponding software can be used without major modification.

According to the invention, this is done using a method of the type specified at the start, in which mixing is carried out in a digital signal processor of an ISDN interface module, with the control of the data streams being managed by a module for communication according to the Media Gateway Control Protocol, which replaces the control of a B channel in the ISDN interface module.

According to the prior art, many telecommunication terminals incorporate an ISDN interface module as a standard feature or can easily be retrofitted with such a module. According to the invention, the digital signal processor which is normally integrated in such an interface module is used to mix data streams, in particular so-called RTP streams, in order thus to manage a conference call between several subscribers. The data streams are controlled by a module for communication according to the Media Gateway Control Protocol, which replaces the control of a B channel in the ISDN interface module.

The Media Gateway Control Protocol, abbreviated to MGCP protocol, is an open protocol, which—though not standardized by the ITU and the IETF—has nevertheless become established in the field of packet-switched telecommunications and thus constitutes a quasi-standard. MGCP converts the audio signals from the public telephone network into data packets for transporting via the internet, thus guaranteeing the communication between media gateway controllers and media gateways. The protocol combines IP Device Control with the Simple Gateway Control Protocol. Since the MGCP architecture transfers the entire call control to external monitoring elements or agents, these functions no longer need to be integrated in the gateways.

In this way most existing functions can continue to be used for ISDN. The invention can therefore be implemented at comparatively small cost.

It is also advantageous here if the processing of an ISDN Layer 2 is managed by a module for communication according to the Stream Control Transmission Protocol.

Using the SCTP protocol, network operators can conduct the signaling messages of their switching systems over the internet and implement new services more easily. The mechanisms of the method are thus used to increase the efficiency and reliability of the internet protocol, since they facilitate the transportation of signaling messages, for example of signaling system No. 7. SCTP was developed by the IETF and also takes over tasks over and above the signaling transport. For this reason SCTP is set in the IP protocol stack on the same level as the TCP protocol and the UDP protocol, so that SCTP can always be used if an application requires the particular performance capability of the new protocol.

Furthermore, it is advantageous if the SIP protocol is used instead of the Media Gateway Control Protocol for the method according to the invention.

The SIP protocol is a signaling protocol that can set up, modify and terminate sessions involving two or more subscribers. This text-oriented protocol, which is based on HTTP, is used for transferring real-time data via packet-controlled networks. The SIP protocol is functionally comparable to the H.323 protocol and can transfer interactive communication services, including voice, via IP networks. The SIP information can be transported via the TCP protocol or the UDP protocol. SIP has an open, internet-based structure and enables—for example—the caller's identity to be transferred or calls to be forwarded in IP-based networks. In addition, SIP is more secure than H.323 because it uses only two defined TCP ports, whilst H.323 requires the entire bandwidth of dynamic ports.

The object of the invention is also achieved with a telecommunication terminal having an ISDN interface module, whereby this incorporates, integrated in the ISDN interface module, a digital signal processor for mixing data streams, and a module for communication according to the Media Gateway Control Protocol for controlling data streams.

As already mentioned, many telecommunication terminals incorporate an ISDN interface module as a standard feature, or can easily be retrofitted with one. According to the invention, the digital signal processor integrated in such an interface module is used to mix data streams in order thus to manage a conference call between several subscribers, with the data streams being controlled by a module for communication according to the Media Gateway Control Protocol.

It is noted that the advantages and variants specified for the method according to the invention also apply equally for the telecommunication terminal according to the invention.

It is therefore also advantageous if the telecommunication terminal incorporates a module for communication according to the Stream Control Transmission Protocol for processing of an ISDN Layer 2 or if the SIP protocol is used instead of the Media Gateway Control Protocol.

The invention will now be explained in greater detail below on the basis of an exemplary embodiment illustrated in the diagrams, which relates to a conference call between several subscribers.

### BRIEF DESCRIPTION OF THE DRAWINGS

FIG. 1 shows a telecommunication terminal for mixing media streams according to the prior art;

FIG. 2 shows a telecommunication terminal for mixing media streams according to the invention.

### DETAILED DESCRIPTION OF INVENTION

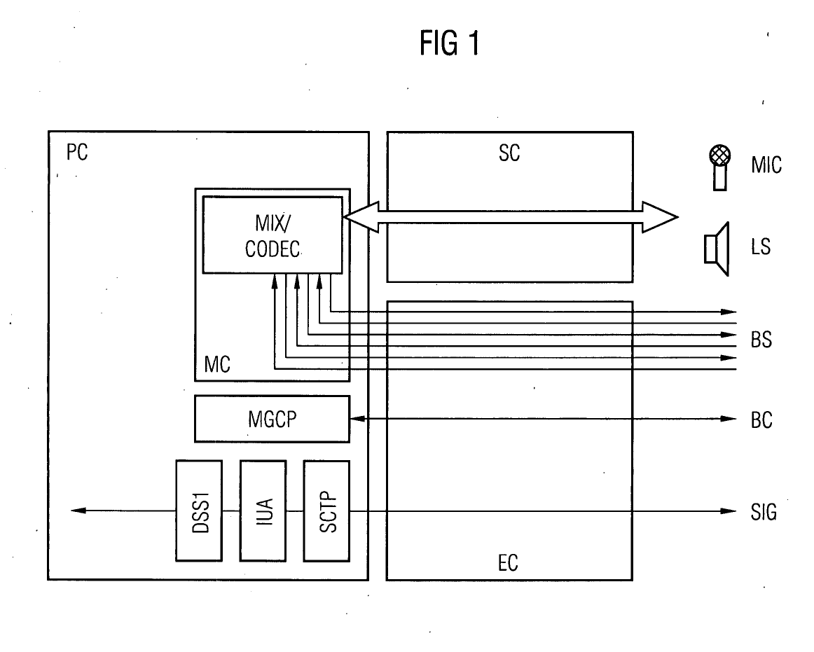

FIG. 1 shows a personal computer PC which incorporates the following modules: a media controller MC, which also contains a combined mixing and compression/decompression level MIX/CODEC, a module for communication according to the Media Gateway Control Protocol (abbreviated to MGCP module), MGCP, a module for communication according to the Stream Control Transmission Protocol (abbreviated to SCTP module), SCTP, a module for communication according to the ISDN User Adaptation Layer protocol (abbreviated to IUA module), IUA, and a module for communication according to the Digital Subscriber System No. 1 protocol (abbreviated to DSS1 module), DSS1.

In the DSS1 protocol, multiple numbers can be allocated and independent ISDN line features for each individual call number. Furthermore, the DSS1 protocol differentiates between four code sets for information elements. The code set 0 corresponds to the control code set according to Q.931, code set 5 to the ETSI code set, code set 6 is for national applications and code set 7 for private applications via the private branch exchange. The network currently uses only the code set 0.

The personal computer PC is additionally connected to an audio interface SC, to which a microphone MIC and a loudspeaker LS are connected, and a network interface EC.

The arrangement shown in FIG. 1 functions as follows:

An audio signal is picked up by the microphone MIC and conducted via the audio interface SC to the combined mixing and compression/decompression level MIX/CODEC, where it is converted into one or more data streams BS, which are conducted via the network interface EC to other voice subscribers not shown in FIG. 1. Data streams BS are also received from these voice subscribers via the network interface EC, said data streams being decompressed by the combined mixing and compression/decompression level MIX/CODEC and mixed to produce an output signal. This output signal is transferred via the audio interface SC to the loudspeaker LS, which broadcasts the signal. The data streams BC are controlled via the MGCP module MGCP. Signaling SIG is handled via the SCTP module SCTP, the IUA module IUA and the DSS1 module DSS1, with the connection to the network in turn being effected via the network interface EC.

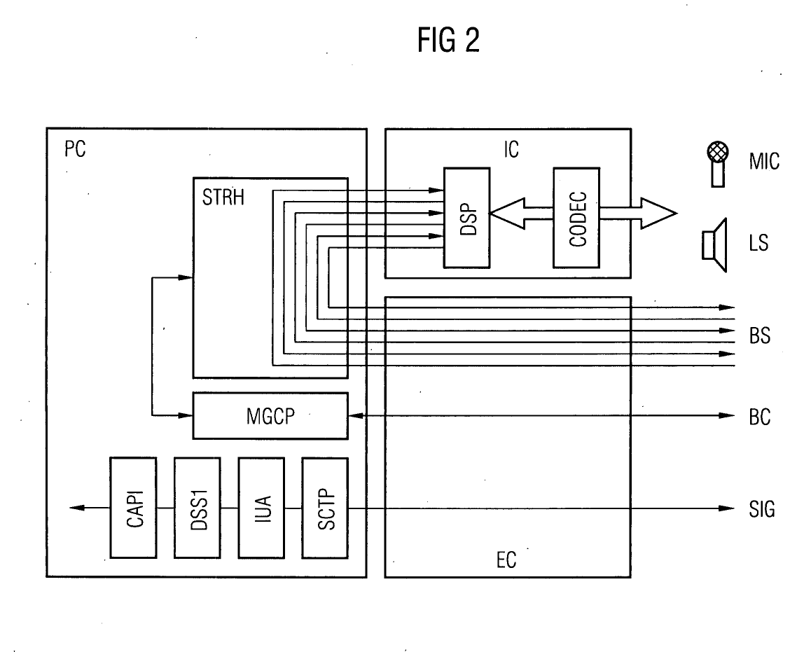

This arrangement has a few disadvantages: in particular, the computing operations necessary for mixing and/or for compression/decompression place a heavy burden on the processor of the personal computer PC. This disadvantage is overcome by the arrangement according to the invention as shown in FIG. 2, since these stages are carried out in a signal processor DSP which has been optimized for these tasks.

FIG. 2 shows a personal computer PC, which in turn incorporates the following modules: an MGCP module, MGCP, an SCTP module, SCTP, an IUA module, IUA and a DSS1 module, DSS1. In addition, the personal computer PC incorporates a stream handler STRH and a Common Application Programming Interface, abbreviated to CAPI interface.

CAPI has become established for ISDN communication as the standard for the interface between application and card driver and thus represents a software interface that permits ease of access to ISDN adapter cards and guarantees unlimited use of their functions. Important features of the CAPI interface include support of several B-channels for data and voice, use of the B channel protocol for call control, support for several logical connections via a physical connection, and support of one or more basic connections or primary multiplex connections.

Furthermore, the personal computer PC is again connected to a network interface EC. In this case, however, instead of the audio interface SC there is an ISDN interface module IC, to which a microphone MIC and a loudspeaker LS are connected. The ISDN interface module IC contains a digital signal processor DSP and a compression/decompression level CODEC.

The arrangement shown in FIG. 2 functions as follows:

An audio signal is picked up by the microphone MIC and forwarded to the ISDN interface module IC. This audio signal is compressed in the compression/decompression stage CODEC, and converted into one or more data streams BS in the digital signal processor DSP; said data streams are conducted via the stream handler STRH to the network interface EC and, from there, to other voice subscribers not shown in FIG. 2. Data streams BS are also received from these voice subscribers via the network interface EC, said data streams likewise reaching the digital signal processor DSP via the stream handler STRH and being mixed into an output signal in said digital signal processor DSP. From there, the mixed signal reaches the compression/decompression stage CODEC, where it is decompressed and subsequently transferred to the loudspeaker LS. The data streams BC are again controlled via the MGCP module MGCP, which—unlike in FIG. 1—communicates with the stream handler STRH for this purpose. Signaling SIG is handled via the SCTP module SCTP, the IUA module IUA, the DSS1 module DSS1 and—in addition—the CAPI interface, with the connection to the network being in turn effected via the network interface EC.

1-6. (canceled)

7. A method for mixing data streams in a telecommunication terminal having an ISDN interface module, comprising:
mixing the data streams by a digital signal processor of the ISDN interface module; and
controlling the data streams by a communication control module using the Media Gateway Control Protocol (MGCP).

8. The method according to claim 7, wherein the communication control module replaces control of a B channel in the ISDN interface module.

9. The method according to claim 7, wherein an ISDN Layer 2 is processed by a communication module according to the Stream Control Transmission Protocol (SCTP).

10. The method according to claim 8, wherein an ISDN Layer 2 is processed by a communication module according to the Stream Control Transmission Protocol (SCTP).

11. The method according to claim 7, wherein the SIP protocol is used instead of the Media Gateway Control Protocol.

12. The method according to claim 8, wherein the SIP protocol is used instead of the Media Gateway Control Protocol.

13. The method according to claim 9, wherein the SIP protocol is used instead of the Media Gateway Control Protocol.

14. A telecommunication terminal, comprising:
an ISDN interface module having a digital signal processor adapted to mix data streams; and
a module for communication for controlling data streams according to the Media Gateway Control Protocol (MGCP).

15. The telecommunication terminal according to claim 14, further comprising a module for communicating according to the Stream Control Transmission Protocol (SCTP) for processing of an ISDN Layer 2.

16. The telecommunication terminal according to claim 14, wherein the SIP protocol is used instead of the Media Gateway Control Protocol.

17. The telecommunication terminal according to claim 15, wherein the SIP protocol is used instead of the Media Gateway Control Protocol.
